(19) United States
(12) Patent Application Publication
(10) Pub. No.: US 2011/0028546 A1
(43) Pub. Date: Feb. 3, 2011

(54) NOVEL ANTIMICROBIAL FORMULATIONS INCORPORATING ALKYL ESTERS OF FATTY ACIDS AND NANOEMULSIONS THEREOF

(76) Inventor: Belle Kumar, Maharashtra (IN)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/376,553

(22) PCT Filed: Aug. 6, 2007
(86) PCT No.: PCT/IN2007/000334

§ 371 Date: Oct. 21, 2010

(30) Foreign Application Priority Data
Aug. 6, 2006 (IN) 181/MUM/2006

(51) Int. Cl. A01N 37/02; A01P 1/00

(52) U.S. Cl. 514/546

(57) ABSTRACT

The present invention relates to a novel antimicrobial composition and method comprising any of the C1-C4 monohydric alcohol esters of C8 to C22 fatty acids, and most preferably the C1-C4 monohydric alcohol esters of C8 to C12 fatty acids, namely, caprylic, capric, and lauric fatty acids. Specifically the invention is related to a composition and method to disinfect various surfaces and substrates including the surfaces of food products, animal and human tissue and appendages, inanimate objects of various compositions, and also enclosed spaces. The invention can be incorporated into various media including liquids, gels, powders, paints, sealants, and the like and can be in the form of emulsions including nanoemulsions.

### TECHNICAL FIELD

The present invention relates to a novel antimicrobial composition, a disinfectant, and method of preparing same comprising use of any of the C1-C4 monohydric alcohol esters of C8 to C22 fatty acids, and most preferably the C1-C4 monohydric alcohol esters of C8 to C12 fatty acids, namely, caprylic, capric and lauric fatty acids or their combinations as the main active ingredients, with or without one or more additional ingredients. The invention also includes methods of disinfection using the said disinfectant.

### BACKGROUND OF THE INVENTION

There is a heightened awareness of the dangers posed by various infectious diseases today. The cross-border spread of various diseases like bird flu, human influenza, and antibiotic resistant tuberculosis to name just a few has increased the need for effective countermeasures that are both safe and effective.

Globalization has resulted in unprecedented movement of people across long distances creating the possibility of extensive spread of pathogens. Also the widespread commercialization of animal husbandry has lead to huge losses in terms of flocks being culled to protect against bird flu which has spread globally.

Additionally, hospitals worldwide are having to deal with in-house or “nosocomial” infections. These infections, which are acquired by patients during hospital stays, are caused largely by microbial contamination of surfaces, and are characterized by being typically antibiotic resistant, and hence potentially deadly.

Thus, the importance of safe, yet highly effective antimicrobial compositions can be easily appreciated by those who are expert in the field as well as by laypersons. The application of an effective and safe to use antimicrobial on various surfaces through which the spread of potentially deadly microbes can be halted is increasing in importance.

Antimicrobials using fatty acid monoesters of glycerol and propylene glycol have been disclosed in U.S. Pat. Nos. 5,460,833 and 5,490,992. These monoesters show effectiveness against a broad range of microorganisms but are expensive to manufacture. U.S. Pat. No. 6,699,907 also teaches the use of propylene glycol in combination with medium chain fatty acids as antimicrobials.

The present invention is a novel composition that is economic and meets the safety, as well as effectiveness criteria for modern antimicrobials especially for use in agricultural, food processing, healthcare, security, manufacturing, cosmetic, and domestic applications.

Throughout this specification, unless the context does not permit that meaning, mention of a singular, with or without the phrase “one or more of” shall include pleural also of the same or any of functional equivalent of the same, any homologue or analogue of the same and also includes mention of any one of a homologue or an analogue them or more of them separately or in a combination. Thus, mention of “a C1-C4 monohydric alcohol” includes mention of any one or more than one C1-C4 monohydric alcohols, including Methanol, Ethanol, Propanol and Butanol either separately or in combination. Conversely, unless context does not permit, use of a plural also includes mention of a singular or any one of a homologue or analogue or equivalent of the same. Thus mention of “C1-C4 monohydric alcohols” includes use of any one of C1-C4 monohydric alcohol also; or a mention of “emulsifiers and surfactants” includes use of only one of any of an emulsifier and/or a surfactant or a substance that can discharge the function of an emulsifier or a surfactant, whether specifically mention or not in the specification. Further, description of the embodiments, examples, compositions described in this specification are for the illustrative purpose only and are not to be construed to limit the scope of subject matter that is inherent in the claims and any variations that are obvious to a person skilled in the art and any possible equivalent and not expressly mentioned in this specification are construed to be included within the scope of claims.

### SUMMARY OF THE INVENTION

In the following are described embodiments of this invention in brief.

In broadest aspect, this invention embodies one or more of an antimicrobial composition comprising a monohydric alcohol ester of a fatty acid, further comprising one or more of a C1-C4 monohydric alcohol ester of one or more of a fatty acid including a C8 to C22 fatty acid; most preferably the C1-C4 monohydric alcohol ester of one or more of a C8 to C12 fatty acid including a caprylic, capric, lauric fatty acid and their mixture; the said fatty acid being sourced from chemical synthesis or from a natural source including coconut oil.

This invention also embodies one or more of a method of using a composition of this invention for disinfection of a surface of an article or an article itself against a broad spectrum of microorganisms.

This invention also embodies a method of using a composition of this invention for facilitating the reduction, control or elimination of a threat posed by one or more of a microorganism by reducing their level in various situations and an application including agricultural processing, food processing, a healthcare application and the like, manufacturing, and domestic situations and applications. Certain embodiments of the present invention are also safe for human and animal consumption thereby widening the areas of application of the composition and method.

A composition of the present invention contains one or more of a C1-C4 monohydric alcohol ester of caprylic, capric or lauric fatty acid and their mixture including those found in C1-C4 monohydric alcohol esters of coconut oil.

In a further embodiment of this invention, a composition of this invention includes its use in a concentrated form; more preferably, mixed in an aqueous or non-aqueous vehicle before use.

In yet further embodiment of this invention, a composition may contain one or more of a food-grade ingredient that is Generally Regarded as Safe (GRAS).

Additionally, this invention also includes a composition that may contain one or more of an essential oil extracted from a plant including but not limited to clove (Syzygium aromaticum L.), cinnamon (Cinnamomum zeylanicum Blume.), basil (Ocimum sanctum L.), lemon grass (Cymbopogon citrates DC.), pepper (Piper nigrum L.), cardamom (Cardamomum officinale Salis.), ginger (Zingiber officinale Rose.), coriander seed (Coriandrum sativum L), orange peel—including D-Limonene—(Citrus species), sage (Salvia officinalis L.), pomegranate (Punica granatum L.), etc.

Additionally the composition of this invention may also contain a phenolic compound including but not limited to Butylated Hydroxtoluene (BHT), Butylated Hydroxanisole (BHA), and Tertiary Butyl Hydroquinone (TBHQ).

Additionally, the a composition of this invention may also contain an alpha hydroxy acid including but not limited to a lactic acid, malic acid, glycolic acid, citric acid and tartaric acid as well as one or more of a beta hydroxy acid, salicylic acid as a synergist for organisms like E. coli, which may also act as an enhancer against many other microorganisms.

Additionally, a composition of this invention may contain one or more of a chelator including but not limited to the a sodium, potassium, calcium, or magnesium salt of ethylenediaminetetraacetic acid (EDTA), gluconic acid and its salts, glycolic acid and its salts, citric acid and its salts, and/or another chelator known to the art.

Additionally, a composition of this invention may contain one or more of an emulsifier, and/or a surfactant including but not limited to a sorbitan ester of a fatty acid, a polyoxyethylene sorbitan ester of a fatty acid, a fatty acid alkanolamide, a nonyl phenol ethoxylate, a sugar ester, an ethoxylated fatty alcohol, an ethoxylated fatty acid, an ethoxylated & propoxylated aliphatic fatty acid, an alkyl glucoside, a polyglucoside, a fatty acid ethoxylate, a salt of an acyl lactylate, a salt of dioctyl sulphosuccinate, and a variety, of other suitable nonionic, cationic, anionic, and zwitterionic surfactant and the like. An emulsifier and/or a surfactant of the invention renders the antimicrobial ingredient miscible in water through emulsification and as such allows for the dilution of a concentrated composition. A surfactant may also, as the need demands, serve as a surface cleaner, and to increase the penetrating power of an antimicrobial composition by reducing the surface tension when used on a substrate with a hard to reach area. An emulsifier and a surfactant is typically amphiphilic, which means that its molecule contains one or more of a distinct hydrophilic and a hydrophobic region.

Additionally a composition may contain one or more of a C1-C10 monohydric alcohol.

Additionally a composition of this invention may contain one or more of a gel and a gelling agent, a thickener, and a viscosity improver of various kinds. A thickener, gelling agent, and a viscosity improver includes but is not limited to sodium carboxymethylcellulose, xanthan gum, corn starch, petrolatum, etc.

Additionally a composition may contain one or more of a rapidly evaporating volatile solvent.

Additionally a composition may be mixed with a powder including but not limited to calcium carbonate, talc, starch, zinc oxide, titanium dioxide, dolomite, etc. to form powdered compositions capable of being handled and/or being applied the said composition as a dry powder.

Additionally, a composition may also be in the form of single component, or a two-component system, or even a multi component system that may be made available as a kit.

Additionally a composition may contain water.

A composition may be in one or more of a form in which an antimicrobial composition can be prepared and applied to achieve an anti-microbial effect, including but not limited to a form of a liquid—as a liquid concentrate, a water-based emulsion, an alcohol-based liquid, a nano-emulsion—as a thickened gel, as a cream or a lotion, as a powder, incorporated in a wax, and the like.

A composition may be also in the form of a nano-emulsion.

A composition may also be incorporated into a cloth, paper, or a porous fabric suitable for use as an antimicrobial wipe, or a bandage, or a dressing for skin or any other substrate.

Alternatively, the present invention includes a method to disinfect a substrate through contacting the said substrate with a concentrated composition. The said substrate may be a food substrate or a non-food substrate.

In another aspect, the present invention includes a method wherein a surface is disinfected through contact with a water diluted mixture of the composition. The said substrate may be a food substrate or a non-food substrate.

In another aspect, the present invention includes a method wherein a substrate is disinfected through contact with a non-water diluted mixture of the composition. The said substrate may be a food substrate or a non-food substrate.

In another aspect, the present invention includes a method to disinfect a substrate through contacting the said surface with the concentrated composition. The said substrate may be human tissue or animal tissue. The said human tissue or animal tissue may be a live tissue or a dead tissue.

In another aspect, the present invention includes a method to disinfect a substrate through contacting the substrate with a water-diluted mixture of the composition. The said substrate may be human or animal tissue. The human tissue or animal tissue may be a live tissue or a dead tissue.

In another aspect, the present invention includes a method to disinfect a substrate through contacting a substrate with a non-water diluted mixture of the composition. The said substrate may be human or animal tissue. The human tissue or animal tissue may be a live tissue or a dead tissue.

In another aspect, the present invention includes a method wherein an undiluted composition is mixed with food in order to impart antimicrobial protection to the food article, or to provide residual protection to the food article once the composition has been added to the food item.

In another aspect, the present invention includes a method wherein a water-diluted composition is mixed with food in order to impart antimicrobial protection to the food article, or to provide residual protection to the food article once the composition has been added to the food item.

In another aspect, the present invention includes a method wherein a non-water diluted composition is mixed with food in order to impart antimicrobial protection to the food article, or to provide residual protection to the food article once the composition has been added to the food item.

In another aspect, the present invention includes a method wherein a water-diluted composition is used to disinfect the surfaces of an enclosed space, the said enclosed space being a room, a chamber, or any other enclosed space in need of disinfection.

The invention also includes the ability of the said composition to impart residual antimicrobial effectiveness to a surface to which it has been applied.

### DETAILED DESCRIPTION OF THE INVENTION

The present invention relates to an antimicrobial composition and a method for its use in eliminating or controlling microbial contamination on a wide variety of substrates, encompassing a broad range of one or more applications.

The said antimicrobial composition may be used to reduce or eliminate microbial contamination on a surface such as a metallic surface including but not limited to steel, copper, aluminium, and one or more of their respective alloys; on a surface made of one or more of a polymeric material including but not limited to a polyethylene, a polypropylene, a nylon, a polylactate, a polyglycolate, and a polyacetate; on a hard surface including but not limited to a medical device and appliance, a countertop, a tabletop, a floor, a ceramic surface including but not limited to a tub, a bath, a sink; and on a woven and non-woven fabric including a synthetic and a non-synthetic.

The said antimicrobial composition may also be used on a human tissue or other mammalian tissue including but not limited to skin, various types of a wound, and a mucus membrane.

The large variety of one more of a substrate allows for the application of the said antimicrobial in a broad range of applications including a commercial application in an industry such as agriculture, food processing, healthcare, manufacturing, as well as in domestic situations and applications. Agricultural application includes but is not limited to equipment cleaning and surface treatment of agricultural produce. A food processing application may include without being limited to equipment cleaning, surface treatment of a processed foods or foods under process, and mixing of an antimicrobial composition of this invention into a processed food item. A healthcare application includes, without being limited to, decontamination of one or more of a surface including surface of a medical instrument, a hospital or a clinic, a glove, skin, a clean room, an operating room surface and the like. A manufacturing application includes but, without being limited to, decontamination and maintenance of asepsis in a clean room and a surface in general. A domestic situation may include, without being limited to a kitchen disinfection, bathroom disinfection, hand and body cleaning, food cleaning and decontamination.

A percentage concentration of one or more of an ingredient or a component of the present invention mentioned below is expressed as total weight-percent of a concentrated formulation, which may or may not be subsequently diluted with water or another solvent prior to end use.

One or more of a fatty acid ester of the present invention is the principle active ingredient of the present invention. By themselves they exhibit antimicrobial activity against at least one organism. The fatty acid esters of the present invention are comprised of the C1-C4 monohydric alcohol esters of C8 to C22 fatty acids, and most preferably the C1-C4 monohydric alcohol esters of C8 to C12 fatty acids, namely, caprylic, capric, and lauric fatty acids as the active ingredients. Over 60% of the fatty acids in natural coconut oil are C8 to C12 fatty acids. Hence, coconut oil transesterified with any of the C1 to C4 monohydric alcohols is a suitable active ingredient of an antimicrobial formulation of this present invention. Monohydric alcohol esters of C8 to C12 fatty acids and more specifically the methyl and ethyl esters of C8 to C12 fatty acids are approved food flavoring substances under United States CFR Title 21, Part 172, section 172.515.

A fatty acid ester which forms the principle active ingredient of composition of present invention can be described to have the general formula CH₃(CH₂)ₘCOO(CH₂)ₙCH₃ where m=6, 8, or 10 and n=0, 1, 2, or 3.

An antimicrobial composition of the present invention may also contain as an optional adjuvant, one or more of an extract of one or more of a plant containing essential oils. An essential oil adjuvant includes, without being limited to, one or more of the following: clove (Syzygium aromaticum L.), cinnamon (Cinnamomum zeylanicum Blume.), basil (Ocimum sanctum L.), lemon grass (Cymbopogon citrates DC.), pepper (Piper nigrum L.), cardamom (Cardamomum officinale Salis.), ginger (Zingiber officinale Rose.), coriander seed (Coriandrum sativum L), orange peel (Citrus species), sage (Salvia officinalis L.), pomegranate (Punica granatum L.), etc. Many essential oils have been reported to exhibit antimicrobial activity against specific microorganisms and also work as food preservatives. For example, Nascimento et al, Braz. J. Microbiol. 31:247-256 (2000) report the antibacterial activity of several plant oils against antibiotic resistant strains of bacteria.

An antimicrobial composition of the present invention may also optionally contain one or more of a phenolic compound including but not limited to Butylated Hydroxytoluene, Butylated Hydroxyanisole, and Tertiary Butylhydroquinone. The quantities or concentrations of these compounds vary depending upon the particular application and may serve as an antioxidant or/and as an additional antimicrobial enhancer, antimicrobial component depending on the concentration used.

An antimicrobial composition of the present invention may also contain, optionally, as an antimicrobial synergist for E. coli and organisms related to the same in their susceptibility towards a composition of this invention and as an enhancer/augmenter for other unrelated micro-organisms, one or more of an alpha hydroxy acid including, without being limited to, lactic acid, malic acid, glycolic acid, citric acid and tartaric acid as well as one or more of a beta hydroxy acid including without being limited to salicylic acid. Wherever relevant, one or more of an enantiomer of an alpha hydroxy acid may be used effectively as a synergist or as an antimicrobial enhancer. The preferred concentration of the alpha hydroxy acids is between 0.5% and 4% depending on the application. A beta hydroxy acid of this invention includes, without being limited to a salicylic acid. Preferred concentration of the beta hydroxy acid is between 0.5% and 5%.

Typically a chelator is one or more of an organic compound that binds with a metallic atom or a metallic ion in solution at multiple sites to form a complex usually in the form of a ring. An exemplary chelator useful in a composition of this invention includes, without being limited to, one or more of a sodium, potassium, calcium, and magnesium salt of ethylenediaminetetraacetic acid (EDTA), gluconic acid and its salts, glycolic acid and its salts, citric acid and its salts, and another chelator known to the art. A chelator may be used in preferred concentrations between 0.25% and 5%.

An emulsifier and/or a surfactant of the invention renders the antimicrobial ingredient miscible in water through emulsification and as such allows for the dilution of a concentrated composition. A surfactant may also, as the need demands, serve as a surface cleaner, and to increase the penetrating power of an antimicrobial composition by reducing the surface tension when used on a substrate with a hard to reach area. An emulsifier and a surfactant is typically amphiphilic, which means that its molecule contains one or more of a distinct hydrophilic and a hydrophobic region.

Exemplary emulsifiers and surfactants of an antimicrobial composition include, without being limited to, a sorbitan ester of a fatty acid, a polyoxyethylene sorbitan ester of a fatty acid, a fatty acid alkanolamide, a nonyl phenol ethoxylate, a sugar ester, an ethoxylated fatty alcohol, an ethoxylated fatty acid, an ethoxylated & a propoxylated aliphatic fatty acid, an alkyl glucoside and a polyglucoside, a fatty acid ethoxylate, a salt of an acyl lactylate, a salt of dioctyl sulphosuccinate, and a wide variety of one or more of another suitable nonionic, cationic, anionic, and/or zwitterionic surfactant. One or more of a combination of an emulsifier and a surfactant may be used advantageously and in a concentration ranging from 1% to 90%.

C1 to C10 monohydric alcohols of the invention may be straight chain or branched chain monohydric alcohols of the general formula R—OH where R is a straight chain or branched chain alkyl group containing 1 to 10 carbon atoms. The most preferable monohydric alcohols of the invention are ethanol and isopropyl alcohol given their well-documented safety and efficacy. The alcohols may be used in preferred concentrations ranging from 10% to 80%.

The physical characteristics of compositions of the invention, depending upon the application, might need to be adjusted. To this end, various thickeners, gelling agents, and viscosity modifiers may be added. The additives mentioned above serve as physical modifiers and have no effect, as such, on the antimicrobial properties of the invention. The thickeners, gelling agents, and viscosity improvers include but are not limited to sodium carboxymethylcellulose, xanthan gum, corn starch, petrolatum, etc.

Rapidly Evaporating Solvents. Rapidly evaporating solvents are used in many everyday applications like surface coatings, penetrating lubricants, etc. The solvents provide greater penetrability, and, after evaporation, even coatings of the dissolved solutes on surfaces and articles where applied. In the context of the present invention, rapidly evaporating solvents provide a vehicle for the easy application of the compositions of the invention to various substrates and situations. The rapidly evaporating solvents may be various types of aerosols, organic solvents, and refrigerants.

Powders. In certain applications, the compositions of the present invention may be incorporated into certain commonly used powders. They include but are not limited to calcium carbonate, talc, starch, zinc oxide, titanium dioxide, dolomite, etc.

In a preferred embodiment, the compositions of the invention may be in liquid form. These liquids may be formulated in the form of concentrates, as water-in-oil emulsions, as pre-diluted emulsions, as ready-to-use alcohol based formulations, as alcohol based concentrates, and as nano-emulsions.

Given that the concentrated compositions of the invention are made up of a hydrophobic antimicrobial component which constitutes the main ingredient or component, and an enhancer, the two may be packaged separately as two separate components in one single kit. Such a two-component composition constitutes a system that may be mixed in various proportions to arrive at a ready to use composition. Additionally, the concentrated compositions may extend into a three-component system as well. The concentrated compositions made up of two or more components, may be mixed, prior to actual use, with a diluent or combinations of diluents that could be water, an alcohol, a gel, a powder, a solvent, an oil, a polymer, or a thickening agent, or any other substance that is suitable. The diluent or diluents may serve as a vehicle for the concentrated composition.

The nanoemulsions are characterized by submicron-sized emulsion droplets which render the composition translucent or nearly transparent. Concentrated liquid compositions, either containing alcohol or not containing alcohol, enjoy the advantage of being easily transported, cost-effective, and are easily metered while diluting. Pre-diluted emulsions and alcohol based ready-to-use formulations are preferred embodiments in some applications where a ready-to-use composition is needed, for example, hand disinfection in medical institutions.

In another preferred embodiment, the compositions of the invention may be in a thickened form. This thickened form may be produced by formulating the composition into a gel. A large number of thickeners or viscosity modifiers are available for this use including the known cellulosic thickeners, various gums, and polymers. Polyethylene glycols of various molecular weights may also be used to provide thickened compositions. Petrochemical-based thickeners such as petrolatum may also be used to produce thickened compositions. The advantage of thickened compositions is apparent in applications where the antimicrobial effect is needed to persist over an extended period of time. Such applications could include the treatment of infections in the nasal cavity, as well as for the control or elimination of microorganisms residing in the vaginal and rectal areas of mammals, and for the treatment of external ear infections.

In another embodiment, the concentrated compositions may contain a small amount of water. The minor amount of water could be incorporated to form a water-in-oil emulsion within the concentrate. The water could also act as a carrier solvent for any water soluble or hydrophilic enhancers, emulsifiers, surfactants, or other adjuvants and additives. The quantity of water could vary from 0.1 weight-percent to 10 weight percent of the concentrated composition. These concentrated compositions containing small amounts of water may also be in the form of lotions or ointments. The concentrated water-containing compositions may also be diluted by water, alcohol, powders, gels, thickeners, polymers or any other suitable diluents to form ready-to-use formulations.

In another embodiment, the compositions of the present invention may be in the form of powders. The compositions may be formulated by incorporating the antimicrobial ingredients into commonly used powders such as calcium carbonate, talc, starch, zinc oxide, titanium dioxide, dolomite, etc. to form powdered compositions. The antimicrobial agents may be incorporated into the powders at a minimum concentration of 0.1 weight-percent to 5 weight-percent.

It will be apparent to those skilled in the art that compositions of the present invention may be combined with antiseptics, antibiotics, antimicrobials, adjuvants, synergists and antimicrobial enhancers existing in the prior art to produce a wide array of compositions with an equally broad range of applications. Indeed, it is conceived that antiseptics, antibiotics, antimicrobials, adjuvants, synergists or antimicrobial enhancers existing in the prior art be combined with compositions of the present invention. It is also contemplated, and obvious to those skilled in the art, that the compositions of the present invention may also contain ingredients that, while not possessing any antimicrobial effect, increase the aesthetic appeal of the compositions, and serve as formulation aids.

As is evident from the above embodiments, compositions of the present invention may be formulated in an exceedingly large number of ways and methods. Following are non-limiting examples given for the purpose of illustration of compositions of this invention and anti-microbial/disinfection activity of some of them. All proportions and percentages are expressed by weight unless mentioned otherwise. The components and materials used to make the exemplary formulations are commercially available unless otherwise stated. Inventory of materials used is given in Table no. 1 in the following:

TABLE 1
Inventory of Materials Used

| | Desig- | |
|---|---|---|
| Name of the Ingredient | nation | Source/Supplier |
| Methyl Laurate | ML12 | Subhash Chemicals, Pune, India |
| Sorbitan Monolaurate | Span 20 | Loba Chemie, Mumbai, India |
| Polyoxyethylene Sorbitan | Tween 20 | Loba Chemie, Mumbai, India |
| Monolaurate | | |
| Lactic Acid 88% | LA 88 | Qualigens, Mumbai, India |
| Butylated Hydroxytoluene | BHT | Qualigens, Mumbai, India |
| Dioctyl Sulphosuccinate | DOSS 50 | Badrivishal Chemicals & |
| 50% | | Pharmaceuticals, Pune, India |
| In Polyethylene Glycol 400 | | |
| Dioctyl Sulphosuccinate | DOSS 70 | Rohit Chemicals, Mumbai, India |
| 50% | | |
| In Polyethylene Glycol 400 | | |
| Clove Oil | Clove Oil | Chemical Process Consultants, |
| | | Mumbai, India |
| Orange peel oil | D- | Chemical Process Consultants, |
| | Limonene | Mumbai, India |
| Polyethylene Glycol 400 | PEG 400 | Neeta Chemicals, Pune, India |
| Isopropyl Alcohol | IPA | Neeta Chemicals, Pune, India |

### Example 1

### Preparation of Coconut Oil Methyl Ester

Coconut Oil Methyl Ester (COME) was prepared in the following manner: 160 grams of methanol was mixed with 3.5 grams of sodium hydroxide (NaOH) and shaken in a closed 250 ml plastic bottle until the NaOH completely dissolved. 910 grams of refined coconut oil in a glass beaker was heated to 50 degrees centigrade over an electric coil heater and the methanol/NaOH mix was added with stirring. The temperature was maintained between 50 and 55 degrees centigrade and the mixture was continuously stirred for 30 minutes. The reaction mixture was then removed from the heat source and allowed to cool for 12 hours. Two distinct layers were observed, an upper layer of coconut oil methyl esters, and a lower glycerin layer. The upper layer of coconut oil methyl esters was then decanted and its pH was measured using commercially available pH paper. Phosphoric acid was added mixed until the pH of the methyl esters was between 7 and 8. The methyl esters were then mixed with 500 grams of water and allowed to settle for 24 hours. The upper layer of methyl esters was then decanted and washed again with 500 grams of water. The upper layer of methyl esters was again decanted and heated to 80 degrees centigrade for 1 hour. The weight of the resultant methyl esters of coconut oil was 804 grams.

### Example 2

### Concentrated Compositions

Concentrated formulations were prepared by mixing the ingredients together in a glass beaker while heating on a hot plate. Ingredients were heated to 50 degrees centigrade while manually stirring with a glass rod or stainless until the ingredients formed a clear homogenous mixture.

Illustrative concentrated compositions are given in Table 2 in the following:

TABLE 2
Concentrated Formulations

| | Composition | | | | | |
|---|---|---|---|---|---|---|
| Ingredients | 1 | 2 | 3 | 4 | 5 | 6 |
| ML 12 | 73.0 | 45.5 | 85.0 | | 20.0 | 70.0 |
| COME | | | | 80.0 | 42.0 | |
| Span 20 | 12.0 | 9.0 | | 5.0 | 7.0 | 3.0 |
| Tween 20 | | 6.8 | 7.5 | 5.0 | 3.0 | 5.0 |
| DOSS 50 | | 9.0 | | 10.0 | 18.0 | 10.0 |
| DOSS 70 | 13.0 | | 7.5 | | | |
| Clove Oil | | 22.7 | | | 10.0 | |
| PEG 400 | | 2.5 | | | | 2.0 |
| BHT | 2.0 | | | | | 1.0 |
| IPA | | | | | | 9.0 |
| Water | | 4.5 | | | | |

### Example 3

### Alcohol-Containing Ready-to-Use Compositions

The ingredients were manually stirred in a glass container until a homogenous, clear mixture was obtained. No external heat was applied. The quantities reported in Table 3 are in weight-percent.

TABLE 3
Alcohol-Containing Ready-to-Use Compositions

| Ingredients | Composition 7 | Composition 8 |
|---|---|---|
| COME | 2.0 | 2.0 |
| D-Limonene | 0.5 | 0.5 |
| PEG 400 | 2.0 | 2.0 |
| LA 88 | — | 0.5 |
| IPA | 95.5 | 95.0 |

### Example 4

### Powder Compositions

Composition 9: 10 grams of Talcum Powder (Pond's Dreamflower, Hindustan Lever Ltd., Mumbai; Ingredients: Talc, Calcium carbonate, Dipropylene Glycol, Fragrance, Vitamin B3, Vitamin E Acetate, Zinc Oxide) was weighed into a steel bowl. 0.5 grams of Formulation 5 was added to the bowl and mixed into the Talcum Powder until all the clumps disappeared. The resultant powder was free-flowing and without clumps.

Composition 10: 0.5 grams of Formulation 5, 0.5 grams of PEG 400, 1.2 grams of IPA, and 0.1 gram of LA 88 were shaken in a test tube until a clear homogenous mixture was obtained. The mixture was then added to 10 grams of Pond's Dreamflower Talcum Powder in a microwave safe bowl were mixed together with a glass rod. The mixture was then heated in a microwave oven (LG Grill, India) at 800 watts for 20 seconds. After removal from the oven the formulation was mixed again with a glass rod until the powder was free flowing and clump-free.

### Example 5

### Ointments

Composition 11: In a test tube, 1.0 gram of Formulation 5 was combined with 1.0 gram of distilled water and 0.2 grams of LA 88. The mixture was shaken vigorously until a milky white emulsion was formed. 10 grams of commercially available white petrolatum was combined with 0.2 grams BHT and placed in a glass beaker and was heated on a hot plate until melted. The emulsion described above was added and the mixture was stirred vigorously until homogenous. The beaker was then removed from heat and cooled by submerging the bottom third of the beaker in a bowl container water. Stirring was continued until the thickened and cooled mixture reached ambient temperature which was 26 degrees centigrade. The formulation was viscous and did not shed any water upon storage for 3 months.

### Example 6

### Nanoemulsions

Composition 12: 100 ml of Composition 4 was processed in a high pressure homogenizer (Niro Soavi, Italy, Model No. NS1001L2K) at between 800 and 1050 bars pressure. An initial dilution ratio of 1 part composition 4 and 3 parts of water was used and passed through the homogenizer 3 times. The resulting emulsion was then further diluted with 4 parts of water and passed through the high pressure homogenizer 5 times. The resulting nanoemulsion was sapphire blue in color, translucent, and contained 6.25% of the antimicrobial composition 5.

### Example 7

### Microbiological Methods, Tests and Investigations

### In Vitro Antimicrobial Efficacy Using Time Kill Procedure

The following target organisms were included in the tests: E. Coli—ATCC No. 8739; Staphylococcus Aureus—ATCC No. 6538 and Candida Albicans—ATCC No. 10231. The initial inoculum counts for all the organisms were between 10⁶ and 10⁸ CFUs/ml.

The testing procedure was according to ASTM E 2315-03 standards and protocols. The exposure times were 2 minutes and 10 minutes. Each test concentration was tested in duplicate and each sample was plated in duplicate.

The log reduction expresses the efficacy of the antimicrobial formulation against the target organism. The final mean number of Colony Forming Units (CFUs) per ml of test solution at a given exposure time log 10 is calculated as follows:

Mean No. of CFUs/ml ═Nₐ=C/(n×D×V)

### Where:

C=Total number of colonies counted on all plates
V=Sample volume used to prepare the pour plate (1 ml)
D=Dilution factor (0.01)
n=Number of plates taken into account
a=exposure time

The mean log reduction is calculated using the equation:

Mean log reduction log 10(N_{I}×0.01)−log 10 (Nₐ)

Where N_{I} is the initial organism count

### Antimicrobial Efficacy of Methyl Laurate

Composition 3 was diluted in water at a concentration of 2 weight percent. The formulation was then tested against the target organisms. The results are detailed in Table 4.

TABLE 4
In vitro testing log reduction for 2% Composition 3

| | S. Aureus | E. Coli | Candida Albicans |
|---|---|---|---|
| 2 minute log reduction | >6.5 | — | 2.66 |
| 10 minute log reduction | >6.5 | 2.44 | >6.5 |

### Antimicrobial Efficacy of Lactic Acid

The lactic acid antimicrobial enhancer was tested against the target organisms at 1.0% concentration. The results are given below:

TABLE 5
In vitro testing log reduction for 1% LA 88

| | S. Aureus | E. Coli | Candida Albicans |
|---|---|---|---|
| 2 minute log reduction | <2.0 | 2.36 | 2.69 |
| 10 minute log reduction | <2.0 | 2.41 | 2.79 |

### Antimicrobial Efficacy of Composition 3 and Lactic Acid Antimicrobial Enhancer

Composition 3 and LA 88 were diluted in water at 2% and 1% concentration respectively. The resultant formulation was tested against the target organisms. The results are tabulated below:

TABLE 6
In vitro testing log reduction for 2% Composition 3 and 1% LA 88

| | S. Aureus | E. coli | Candida albicans |
|---|---|---|---|
| 2 minute log reduction | >6.5 | <2.0 | >6.5 |
| 10 minute log reduction | >6.5 | >6.5 | >6.5 |

The results of Table 4, 5 and 6 show that the combination of the antimicrobial fatty acid ester and lactic acid possesses greater antimicrobial efficacy than any one of the component alone against all 3 target organisms, that the resulting combined anti-microbial activity against E. coli is significantly more than additive effect of both indicating a synergistic effect of the combination. It is contemplated that this synergistic effect will be apparent against several other organisms as well.

### Antimicrobial Efficacy of Composition 2 and Lactic Acid Antimicrobial Enhancer

Composition 2 and LA 88 were diluted in water at 2% and 1% concentration respectively. The resultant formulation was tested against the target organisms. The results are tabulated below:

TABLE 7
In vitro testing log reduction for 2% Composition 2 and 1% LA 88

| | S. aureus | E. coli | Candida albicans |
|---|---|---|---|
| 2 minute log reduction | >6.5 | — | >6.5 |
| 10 minute log reduction | >6.5 | >6.5 | >6.5 |

The above results show that the combination of the ester antimicrobial composition containing clove oil with lactic acid exhibits antimicrobial efficacy comparable to the synergistic combination of the antimicrobial fatty acid ester and lactic acid. In view of the fact that concentration of Methyl Laurate is about 50% of that used in Composition 3 and is replaced by clove oil, it is clear that the concentration of clove oil used in the composition gives an activity that is comparable to the quantity of Methyl Laurate replaced and Composition 2 has an efficacy that is comparable to Composition 3.

### Test for Surface Cleaning Efficacy

Composition 5 and LA 88 were diluted in water at 2% and 1% concentration respectively. The resultant composition was used to disinfect a variety of surfaces in a room including a granite counter, a stainless steel sink, the top of a refrigerator, and the floor. Sterile swabs were used to recover organisms on the above mentioned surfaces prior to treatment with the antimicrobial composition.

The surfaces were then contacted with the antimicrobial composition by spraying with a spray bottle and the surfaces wiped clean with a clean cloth. After a half hour, sterile swabs were again used to recover any organisms on the surface. The swabs were transferred to test tubes containing 1% peptone water, vortexed and plated onto blood agar plates and MacConkey agar plates in duplicate and incubated for 48 hours at 35+/−2 degrees centigrade, after which the colonies were counted.

While the pre-treatment plates showed profuse growth of gram negative bacilli and gram positive cocci, the post-treatment plates no growth at all, except the floor sample which showed 15 colonies of gram positive cocci. The example shows the antimicrobial composition's efficacy as a surface disinfectant with a residual effect.

### Disinfection of a Fruit Surface

Two apples were purchased from the local grocery store. An area of approximately 1 square inch was chosen on each apple. A test suspension containing 100 CFUs/ml of E. Coli ATCC No. 8739 was applied on the chosen area of each apple. The surfaces were allowed to dry. An antimicrobial composition was prepared with 2% Formulation 2 and 1% LA 88. The antimicrobial composition was then applied on the chosen areas of one of the apples and allowed to air dry for 10 minutes. Using sterile swabs, organisms on both the treated areas of the two apples were recovered. The swabs were transferred to test tubes containing 1% peptone water respectively. The test tubes were vortexed to free the cells. Duplicate 1 ml plates were prepared and incubated for 24 hours at 35+/−2 degrees centigrade. The number of colonies on each plate was counted. The plates untreated with the antimicrobial composition had an average of 89 CFUs while the plates treated with the antimicrobial composition had an average plate count of 8 CFUs per plate.

1. An antimicrobial composition comprising (i) one or more of a C1-C4 monohydric alcohol ester of one or more of a C8 to C22 fatty acid, most preferably one or more of a C1-C4 monohydric alcohol ester of one or more of a C8 to C12 fatty acid including caprylic, capric, lauric fatty acid in an antimicrobially effective amount, preferably in a concentration of at least 1 weight percent in a ready-to-use composition, (ii) one or more of an emulsifier, and/or a vehicle, and (iii) optionally one or more of an adjuvant, a phenolic compound, a synergist, a chelator, a monohydric alcohol, a viscosity modifier or a rapidly evaporating solvent, where:
a. an adjuvant comprising preferably one or more of an essential oil extracted from one or more of a plant including clove (Syzygium aromaticum L.), cinnamon (Cinnamomum zeylanicum Blume.), basil (Ocimum sanctum L.), lemon grass (Cymbopogon citrates DC.), pepper (Piper nigrum L.), cardamom (Cardamomum officinale Sails.), ginger (Zingiber officinale Rose.), coriander seed (Coriandrum sativum L), orange peel (Citrus species), sage (Salvia officinalis L.), pomegranate (Punica granatum L.), and like,
b. a phenolic compound further preferably comprising one or more of a BHT (Butylated Hydroxytoluene), BHA (Butylated Hydroxy Anisole), and TBHQ (Tertiary Butyl Hydroxyquinone) and the like,
c. a synergist or a antimicrobial enhancer comprising one or more of a hydroxy acid comprising lactic acid, malic acid, glycolic acid, citric acid, tartaric acid, beta hydroxy acid salicylic acid and like,
d. a chelator, comprising one or more of a ethylenediaminetetraacetic acid (EDTA) including its salts further including a sodium, potassium, calcium and magnesium salts, gluconic acid and/or its salts, glycolic acid and/or its salts, citric acid and/or its salts, and like,
e. a surfactant and/or an emulsifier comprising one or more of a sorbitan ester of a fatty acid, a polyoxyethylene sorbitan ester of a fatty acid, a fatty acid alkanolamide, a nonyl phenol ethoxylate, a sugar ester, an ethoxylated fatty alcohol, an ethoxylated fatty acid, an ethoxylated & propoxylated aliphatic fatty acid, an alkyl glucoside and an alkyl polyglucoside, a fatty acid ethoxylate, a salt of an acyl lactylate, a salt of dioctyl sulphosuccinate, and nonionic, cationic, anionic, one or more of a zwitterionic surfactant and like,
f. a monohydric alcohol comprising preferably one or more of a C1-C10 monohydric alcohol, and more preferably ethanol or isopropyl alcohol,
g. a viscosity modifier comprising a gel, a gelling agent, a thickener, a viscosity improver and the like,
h. one or more rapidly evaporating volatile solvents,
i. a vehicle comprising one or more of water, oil or one or more of a powder comprising calcium carbonate, talc, starch, zinc oxide, titanium dioxide, dolomite, and the like.

2. A composition of claim no. 1 wherein the said one or more of a C8 to 022 fatty acid or its said esters is/are derived as:
a. an isolated chemical or as a mixture of isolated chemicals, including preferably methyl laurate and/or
b. from a natural product or a natural raw material or its derivative, including transesterified coconut oil.

3. A composition as claimed in claim no. 1 or claim no. 2 that may be in the form of a liquid, a liquid concentrate, a water-based emulsion, an alcohol-based liquid, a nano-emulsion, a thickened gel, a cream, a lotion, a powder, incorporated in a wax, a single component system, a two-component system, a multi component system and the like.

4. A composition of the claim 1 or claim no. 2 when incorporated into a carrier medium comprising a cloth, a paper, a porous fabric and the like.

5. A method of disinfection comprising use of composition of any one of claim 1 to claim 4 as at least one disinfecting agent.

6. A method of claim 5 comprising disinfection of a surface or a substrate in an operation or a process.

7. A method of claim 5 further including one or more of the following:
a. a method to disinfect a surface through contacting the surface with the concentrated composition, the said surface comprising surface of one or more of a food article, a non-food article, a metal, steel, copper, aluminium, their respective alloys, polymeric material, a polyethylene, a polypropylene, a nylon, a polylactate, a polyglycolate, a polyacetate, a medical device, a medical appliance, a countertop, a tabletop, a floor, a ceramic surface, a tub, a bath, a sink, a woven and non-woven synthetic fabric, a woven and non-woven non-synthetic fabric and the like,
b. a method to disinfect wherein the surface is disinfected through contact with a water diluted mixture of the composition,
c. a method to disinfect wherein the surface is disinfected through contact with a non-water diluted mixture of the composition,
d. a method to disinfect a surface through contacting the surface with a concentrated composition, the said surface comprising that of a human tissue or an animal tissue; the said human tissue or an animal tissue further comprising live tissue or a dead tissue,
e. a method to disinfect a surface through contacting the surface with a water-diluted mixture of the composition, the said surface comprising a human tissue or an animal tissue; the said human tissue or an animal tissue further comprising a live tissue or a dead tissue,
f. a method to disinfect a surface through contacting the surface with a non-water diluted mixture of the composition, the said human tissue or an animal tissue further comprising a live tissue or a dead tissue,
g. a method to disinfect wherein the said composition, undiluted, is mixed with food in order to impart antimicrobial protection to the food article, or to provide residual protection to the food article once the composition has been added to the food item,
h. a method to disinfect wherein the water-diluted composition is mixed with food in order to impart antimicrobial protection to the food article, or to provide residual protection to the food article once the composition has been added to the food item,
i. a method to disinfect wherein the non-water diluted composition is mixed with food in order to impart antimicrobial protection to the food article, or to provide residual protection to the food article once the composition has been added to the food item,
j. a method to disinfect wherein the water-diluted composition is used to disinfect a surface of an enclosed space, the said enclosed space being a room, a chamber, or an enclosed space in need of disinfection,
k. a method to disinfect wherein the composition is able to impart residual antimicrobial effectiveness to a surface to which it has been applied.

8. A method of claim 4 or claim 5 comprising one or more of a process or a surface including:
a. agricultural processing further including equipment cleaning, surface treatment of agricultural produce and the like,
b. food processing further including equipment cleaning, surface treatment of processed foods, surface treatment of food under process, mixing of the composition into a processed food item and the like,
c. healthcare applications, including decontamination of various surfaces including a medical instrument, a hospital, a clinic surface, gloves, skin, clean room surfaces like operating room surfaces and the like,
d. a manufacturing process, including decontamination and maintenance of asepsis in clean rooms and general surfaces and the like,
e. domestic operations including one or more of a floor cleaning, kitchen disinfection, bathroom disinfection, hand and body cleaning, and food cleaning and decontamination and the like,
f. a surface of a food product,
g. a body surface including an appendage of human, skin, mucous membrane and the like,
h. a body surface including an appendage of an animal, skin, mucous membrane and the like,
i. a surface of an inanimate object,
j. surface of an enclosed space including a room, a house, an operation theatre, a clean room, a working surface and the like
